(19) United States
(12) Patent Application Publication
(10) Pub. No.: US 2024/0367534 A1
(43) Pub. Date: Nov. 7, 2024

(54) ELECTRIC VEHICLE CHARGING SYSTEM WITH MAGNETIC PLUG SYSTEM

(71) Applicant: EVJAM LLC, Minneapolis, MN (US)

(72) Inventors: Steven DICKE, St. Paul, MN (US); Gregg KROMREY, Hudson, WI (US)

(73) Assignee: EVJAM LLC, Minneapolis, MN (US)

(21) Appl. No.: 18/656,522

(22) Filed: May 6, 2024

Related U.S. Application Data
(60) Provisional application No. 63/464,219, filed on May 5, 2023.

(51) Int. Cl. B60L 53/35; B60L 53/16; H01R 13/629; H02J 7/00

(52) U.S. Cl. CPC B60L 53/35; B60L 53/16; H01R 13/629; H02J 7/0042

(57) ABSTRACT

One example provides an electric vehicle (EV) charging system including a charging station having a charging plug including an end surface on which at least one pair of alignment magnets and a plurality of charging contacts are arranged in a layout pattern. A charging port disposed on an EV has at least one pair of alignment magnets and a plurality of charging contacts which are arranged in the layout pattern on a surface of the charging port, the charging port to receive the charging plug, wherein the alignment magnets of the charging plug magnetically align with and magnetically couple to the alignment magnets of the charging port such that the charging contacts of the charging plug are aligned with an in electrical contact with the charging contacts of the charging port.

### CROSS-REFERENCE TO RELATED APPLICATION

This Non-Provisional patent application claims the benefit of the filing date of U.S. Provisional Patent Application Ser. No. 63/464,219, filed May 5, 2023, which is herein incorporated by reference.

### TECHNICAL FIELD

The present disclosure relates generally to examples of electric vehicles and to devices for use with an electric vehicle, including electric vehicle batteries and electric vehicle charging systems and devices.

### BACKGROUND

Electric vehicles offer a quiet, clean, and environmentally friendly option to gas-powered vehicles. Electric vehicles have electric powertrains which typically include a rechargeable battery system, one or more electric motors, each with a corresponding electronic power inverter (also sometimes referred to as a motor controller), and various auxiliary systems (e.g., heating and cooling systems). To enhance ownership and ensure availability, charging EVs should be convenient and timely.

For these and other reasons, there is a need for the present invention.

### SUMMARY

One example of the present disclosure provides an electric vehicle (EV) charging system including a charging station having a charging plug including an end surface on which at least one pair of alignment magnets and a plurality of charging contacts are arranged in a layout pattern. A charging port disposed on an EV has at least one pair of alignment magnets and a plurality of charging contacts which are arranged in the layout pattern on a surface of the charging port, the charging port to receive the charging plug, wherein the alignment magnets of the charging plug magnetically align with and magnetically couple to the alignment magnets of the charging port such that the charging contacts of the charging plug are aligned with an in electrical contact with the charging contacts of the charging port.

Additional and/or alternative features and aspects of examples of the present technology will become apparent from the following description and the accompanying drawings.

### BRIEF DESCRIPTION OF THE DRAWINGS

The Figures generally illustrate one or more examples of an electric vehicle and/or devices for use with an electric vehicle such as electric vehicle batteries or electric vehicle charging systems and devices.

FIG. 1 is a block and schematic diagram generally illustrating an electric vehicle charging system having a magnetic charging plug system, in accordance with one example of the present disclosure.

FIG. 2 is a schematic diagram of an end view and illustrating an end surface of a magnetic charging plug, in accordance with one example of the present disclosure.

FIGS. 3A-3C are schematic cross-sectional views of a magnetic charging plug, according to one example of the present disclosure.

FIG. 4 is a schematic cross-sectional view of a magnetic charging plate adapter, according to one example of the present disclosure.

FIG. 5A is a schematic diagram of an end view and illustrating an end surface of a magnetic charging plug, in accordance with one example of the present disclosure.

FIG. 5B is a schematic cross-sectional view of a magnetic charging plate adapter, according to one example of the present disclosure.

FIG. 6 is a block and schematic diagram generally illustrating an electric vehicle charging system having a magnetic charging plug system, in accordance with one example of the present disclosure.

FIG. 7 is a block and schematic diagram generally illustrating cross-sectional views of a magnetic charging plug and a magnetic charging port, in accordance with one example of the present disclosure.

FIGS. 8A and 8B respectively illustrate implementations of magnets for use with a magnetic charging plug and magnetic charging port, in accordance with examples of the present disclosure.

FIG. 9A is a schematic diagram of an end view and illustrating an end surface of a magnetic charging plug, in accordance with one example of the present disclosure.

FIG. 9B is a schematic diagram of an end view and illustrating an end surface of a magnetic charging plug, in accordance with one example of the present disclosure.

FIG. 10 is a schematic diagram of an end view and illustrating an end surface of a magnetic charging plug and illustrating an interaction between alignment magnets of the magnetic charging plug and a magnetic charging port, in accordance with one example of the present disclosure.

FIGS. 11A and 11B respectively illustrate schematic cross-sectional views of a magnetic charging plug and a corresponding magnetic charging port, according to one example of the present disclosure.

FIG. 12 schematically illustrates an electromagnet, according to one example.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

Electric vehicles offer a quiet, clean, and environmentally friendly option to gas-powered vehicles. Electric vehicles have electric powertrains which typically include a rechargeable battery system, one or more electric motors, each with a corresponding electronic power inverter (also sometimes referred to as a motor controller), and various auxiliary systems (e.g., heating and cooling systems). To enhance ownership and ensure availability, charging EVs should be convenient and timely.

Electric Vehicle Charging System with Magnetic Charging Plug System

EV charging systems typically include a charging station which employs a charging cable and charging plug which connects to a charging port on an EV to be charged. The charging plug of the charging station and the charging port of the EV are typically of a male-female type configuration. While such a configuration makes a secure connection, such connections can sometimes be difficult to make, such as in low light conditions, or for a person having physical limitations.

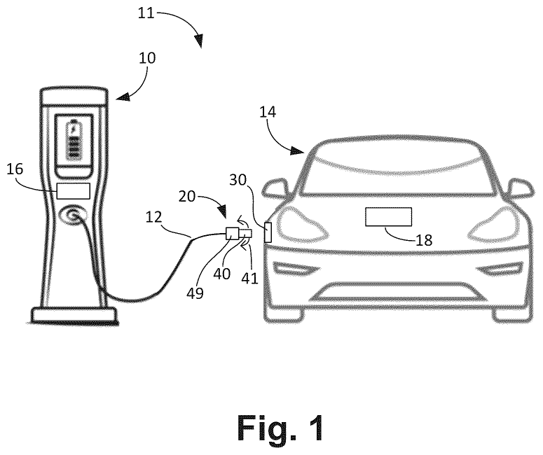

FIG. 1 is block and schematic diagram generally illustrating an EV charging station 10 employing a charging cable 12 having a magnetic charging plug 20 that is configured to magnetically align and mate with a corresponding magnetic charging port on an 30 of an EV 14. In examples, the magnetic charging port 30 may be an integral part of EV 12 (i.e., manufactured therewith), or, as described below, may comprise a magnetic port adapter which is insertable within an existing charging port on EV 14. In examples, magnetic charging plug 20 comprises an electromagnetic charging plug. In examples, magnetic charging plug 20 is configured to magnetically self-align with and connect to EV charging port 30. In one example, as will be described in greater detail below, magnetic charging plug 20 comprises a dual magnetic plug system including a magnetic alignment system and a magnetic coupling system. In one example, the magnetic alignment system operates to auto-align the magnetic charging plug with the EV charging port and to provide a preliminary connection thereto. Upon being preliminarily connected, the magnetic coupling system operates to magnetically secure/lock the magnetic charging plug 20 to EV charging port 30 during a charging operation. In examples, the magnetic plug charging system can be operated electromagnetically.

In examples, EV charging station 10 with magnetic charging plug 20, and magnetic charging port 30 of EV 14 (including an EV controller 18) together represent an electric vehicle charging system 11 employing a magnetic plug system. In examples, peration of the electric vehicle charging system 11 may be done remotely via a computer, EV control system 18, charging station control system 16, or a user control application (e.g., via a phone).

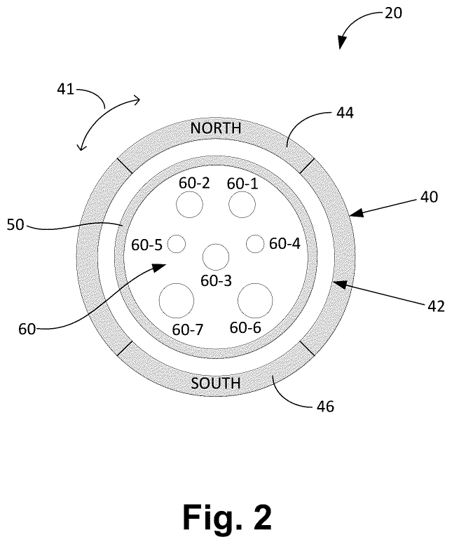

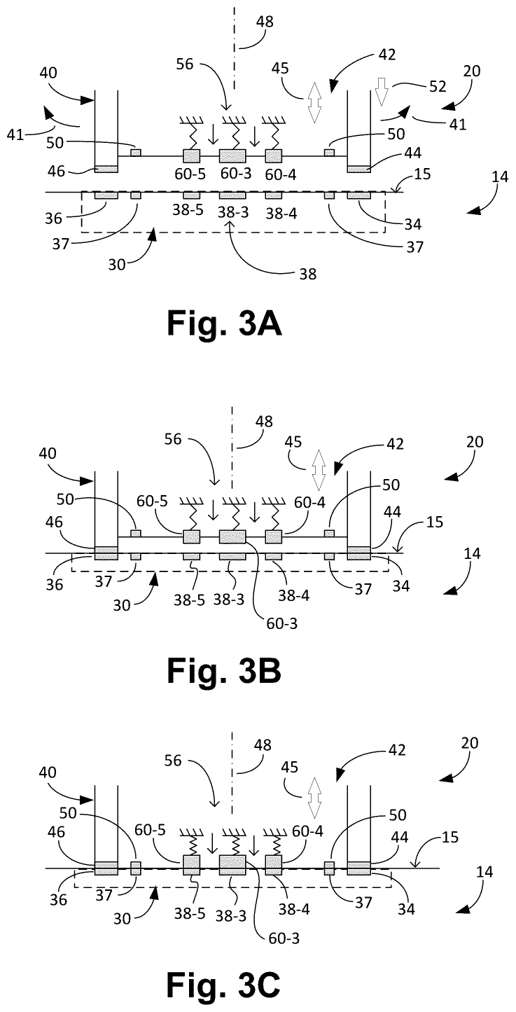

FIG. 2 is a schematic diagram of an end view of magnetic charging plug 20, according to one example. In one example, magnetic charging plug 20 includes a stationary outer body 40, and an inner body 42 that can move relative to stationary outer body 40, as indicated by directional arrows 45 in FIGS. 3A-3C below. In one example, outer body 40 includes a pair of alignment magnets 44 and 46 having opposite polarities, with alignment magnets 44 and 46 respectively illustrated as having the north and south polarities. In one example, with reference to FIG. 1, outer body 40 and inner body 42 are able to spin together about an axis 48 of magnetic charging plug 20 relative to a plug body 49 of magnetic charging plug 20 and relative to charging cable 12, as indicated by rotational arrow 41 (e.g., plug body 49 and charging cable 12 are stationary relative to outer and inner bodies 42 and 42).

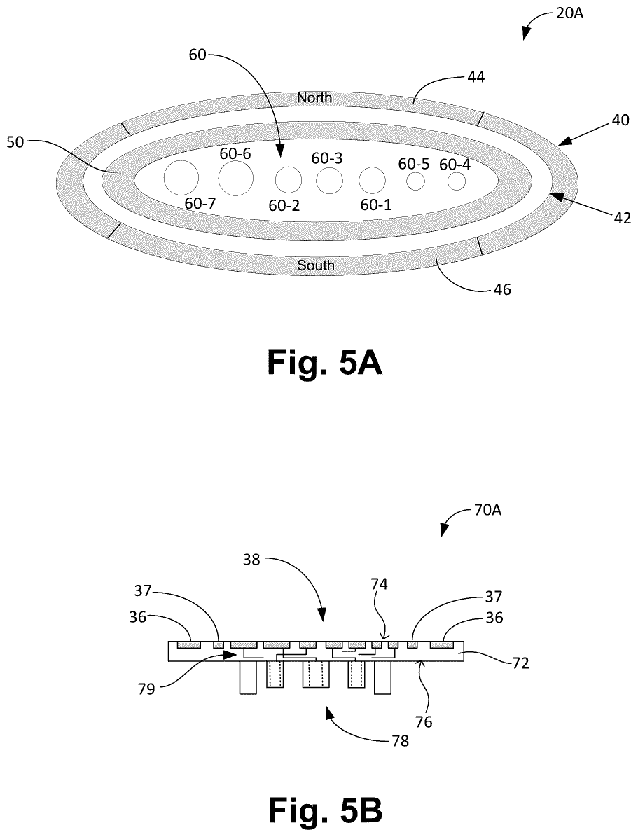

In examples, inner body 42 includes at least one coupling magnet 50. In one example, coupling magnet 50 has a ring-shape that extends in a circular fashion proximate to a perimeter edge of inner body 42. In other examples, coupling magnet 50 may comprise a plurality of individual magnets disposed in a pattern on inner body 42. Inner body 42 further includes a plurality of charging contacts 60, such as standard J1772 contacts (with DC), illustrated as contacts 60-1 through 60-7, where contacts 60-1 and 60-2 are AC Level 1 and Level 2 contacts, contact 60-3 is a ground contact, contacts 60-4 and 60-5 are Control Pilot (CP) and Control Status (CS) contacts, and contacts 60-6 and 60-7 are DC contacts. Although illustrated as generally having a J1772 contact configuration, magnetic charging plug 20 may have any number of configurations and contacts (e.g., see FIGS. 5A and 5B). In examples, magnetic charging plug 20 may include multiple communication contacts to enable communication between EV charging station 10 and EV 14 via magnetic charging plug 20. In other examples, EV charging station 10 may communicate wirelessly with EV 14.

In examples, alignment magnets 44 and 46, and coupling magnet 50 may be permanent magnets or electromagnets. In one example, alignment magnets 44 and 46 comprise permanent magnets and coupling magnet 50 comprises an electromagnet which may be selectively energized during operation by EV charging station 10. In one example, in addition to being used for alignment with magnetic charging port 30, alignment magnets 44 and 46 may also be employed as coupling magnets.

FIGS. 3A-3C are block and schematic diagrams generally illustrating a cross-sectional view of magnetic charging plug 20 and magnetic charging port 30, according to one example of the present disclosure, and illustrating the operation thereof. It is noted that only a portion of charging contacts 60 are illustrated in FIGS. 2A-2C. With reference to FIG. 2A, magnetic charging plug 20 is illustrated as being spaced from magnetic charging port 30 of EV 14. In one example, magnetic charging port 30 includes alignment magnets 34 and 36, a coupling magnet 37, and a plurality of charging contacts 38, illustrated at charging contacts 38-3, 38-4, and 38-5, which respectively correspond to alignment magnets 44 and 46, coupling magnet 50, and charging contacts 60-3, 60-4, and 60-5 of magnetic charging plug 20. In one example, alignment and coupling magnets 34, 35, and 36, and charging contacts 38 are disposed on a surface 15 of EV 14. In examples, alignment magnets 34 and 36 of magnetic charging port 30 respectively correspond to and have the opposite polarity of alignment magnets 44 and 46 of magnetic charging plug 20. In examples, inner body 42 and/or charging contacts 60 are biased toward the end surface of charging plug 20 (i.e., toward magnetic charging port 30) by a biasing mechanism 56 (e.g., springs, elastic surface material, etc.), as indicated by the arrows.

With reference to FIG. 3A, as magnetic charging plug 20 moves toward magnetic charging port 30, as indicated by directional arrow 52, the magnetic fields of alignment magnets 44 and 46 begin to align with corresponding alignment magnets 34 and 36 of magnetic charging port 30, causing outer and inner bodies 40 and 42 to rotate about axis 48, as indicated by rotational arrows 41, until alignment is achieved therebetween. In one example, both alignment magnets 34 and 36 of charging port 30, and alignment magnets 44 and 46 of magnetic charging plug 20 comprise permanent magnets having fixed polarization. In one example, magnets 36 and 44 have a same polarization (e.g., north), and magnets 34 and 46 have a same polarization (e.g., south), such that magnet 44 is repelled from magnet 36 and attracted to magnet 34, and magnet 46 is repelled from magnet 34 and attracted to magnet 36. In other examples, alignment magnets 44 and 46 of magnetic charging plug 20 may be electromagnets which may be energized by a controller 16 of EV charging station 10, and alignment magnets 34 and 36 of magnetic charging port 30 comprise permanent magnets. In examples, alignment magnets 34 and 36, and coupling magnet 50 of magnetic charging plug 20, and alignment magnets 44 and 46, and coupling magnet 37 of magnetic charging port 30 may be any suitable combination of permanent and electromagnets, where operation of electromagnets of magnetic charging plug 20 may be controlled by controller 16 of EV charging station 10, and operation of electromagnets of magnetic charging port 30 may be controlled by a controller of EV 14, such as based on communication with EV charging station 10 via charging plug 20 or via wireless communication.

FIG. 3B illustrates magnetic charging plug 20 after alignment magnets 44 and 46 have aligned with and are magnetically coupled to alignment magnets 34 and 36 of magnetic charging port 30. With reference to FIG. 3C, according to one example, after alignment and an initial magnetic coupling between alignment magnets 44 and 46 of magnetic charging plug 20 with alignment magnets 34 and 36 of magnetic charging port 30, electromagnetic coupling magnet 50 is energized to magnetically couple to coupling magnet 37 of magnetic charging port 30, causing inner body 42 to move toward surface 15 of EV 14 so that coupling magnet 50 magnetically couples to coupling magnet 37, and charging contacts 60 of charging plug 20 are held in contact with charging contacts 38 of charging port 30 and biased there against by biasing mechanism 56. In examples, a magnetic coupling between alignment magnets 44 and 46 of charging plug 20 and alignment magnets 34 and 34 of charging port 30 may represent a preliminary coupling having a weaker magnetic force than a primary magnetic coupling connection between coupling magnets 50 and 37. In other examples, the magnetic coupling between alignment magnets 34, 36 and 44, 46 and between coupling magnets 50 and 37 each comprise a coupling connection.

In one example, to release magnetic charging plug 20 from magnetic charging port 30, a magnetic field of electromagnetic coupling magnet 50 and/or electromagnetic alignment magnets 44 and 46 may be reversed (i.e., direction of current flow through the electromagnets is reversed) to that magnetic charging plug 20 is magnetically repelled from magnetic charging port 30. In other examples, electromagnetic alignment magnets 44, 46 and electromagnetic coupling magnet 50 may be placed in a neutral state (i.e., having no magnetic field) so that magnetic charging plug 20 may be removed from charging port 30. In other examples, the electromagnetic alignment magnets 34 and 36, and electromagnetic coupling magnet 37 may be similarly controlled by EV 14 to reverse or neutralize the magnetic fields to repel and/or release magnetic charging plug 20 therefrom.

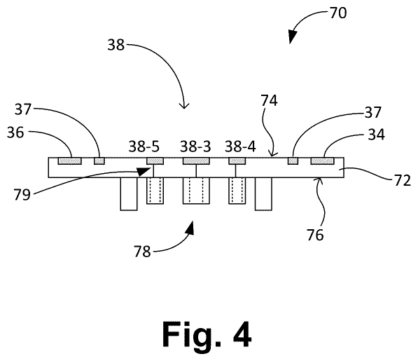

With reference to FIG. 4, in cases where EV 14 includes a standard male or female charging port, and does not include an integral magnetic charging port 30, charging system 11 includes an magnetic charging port adapter plate 70 which may be inserted/plugged into a standard charging EV charging port. FIG. 4 is a schematic diagram generally illustrating a magnetic charging port adapter plate 70, according to one example. As illustrated, charging port adapter plate 70 includes a wiring substrate 72 having an outer surface 74 and an opposing inner surface 76. A plurality of connectors 78 extend from inner surface 76 and are configured to insert into female connectors of a standard charging port of EV 14. Alignment magnets 34 and 36, and coupling magnet 37 are disposed on outer surface 74, along with the plurality of charging contacts 38, illustrated as charging contacts 38-3, 38-4, and 38-5. Wiring substrate 72 includes internal circuitry 79 to provide electrical connections between charging contacts 38 and connectors 78. In examples, internal circuitry 79 further connects alignment magnets 34, 36 and coupling magnet 37 to connectors 78 in a case where alignment magnets 34, 36 and coupling magnet 37 comprise electromagnets controllable via control system 18 of EV 14. In examples, connectors 18 may comprise any number of configurations to enable magnetic charging plate adapter to be employed with any number of unique EV charging port configurations to enable use of magnetic electric vehicle charging system 11 therewith.

FIGS. 5A and 5B respectively illustrate schematic diagrams of examples of a magnetic charging plug 20A and a corresponding magnetic charging port adapter plate 70A having different charging contact and magnet configurations. With reference to FIG. 5A, magnetic charging plug 20 has an oval shape (in lieu of a circular shape of FIG. 2) and charging contacts 68 have a linear configuration (in lieu of a J1772 type configuration of FIG. 2). Similarly, magnetic charging port adapter plate 70A has a configuration of alignment magnets 34, 36 and coupling magnet 37, as well as charging contacts 38 which correspond to the configuration of magnetic charging plug 20A. It is noted that any number of suitable configurations may be employed.

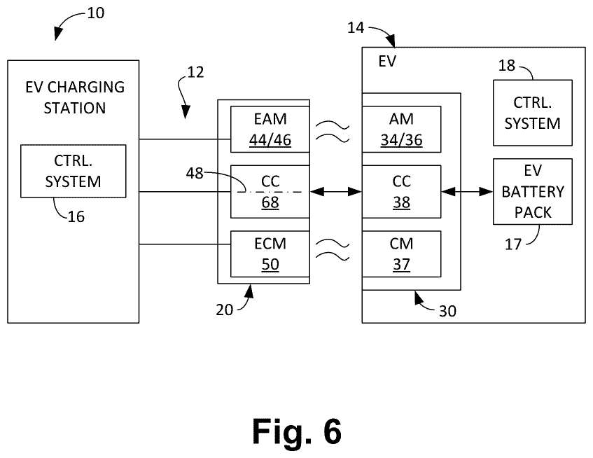

FIG. 6 is a block and schematic diagram generally illustrating electric vehicle charging system 11, according to one example, including EV charging station 10, with EV charging 10 including charging cable 12 having magnetic charging plug 20 which is configured to magnetically align and secure to corresponding magnetic charging port 30 of EV 14. In one example, magnetic charging plug 20 includes electromagnetic alignment magnets 44/46, electromagnetic coupling magnet 50, and a plurality of charging contacts 68 which are configured as surface contacts on an end surface of magnetic charging plug 20. In one example, control system 16 of EV charging station 10 controls energization of electromagnetic alignment magnets 44/46 and electromagnetic coupling magnet 50, where upon energization, electromagnetic alignment magnets 44/46 and electromagnetic coupling magnet 50 produce a controllable magnetic field.

EV 14 includes an electromagnetic charging port 30 having alignment magnets 34/36 and coupling magnet 37 which have a configuration/physical layout configured to match the configuration and physical layout of electromagnetic alignment magnets 44/46 and electromagnetic coupling magnet 50. In one example, alignment magnets 34/36 and coupling magnet 37 comprise permanent magnets. In one example, alignment magnets 34/36 and coupling magnet 37 comprise electromagnetic magnets whose energization is controlled by control system 18 of EV 14 during a charging operation of EV battery pack 17.

In one example, during a charging operation, electromagnetic alignment magnets 44/46 are energized by control system 16 of EV charging station 10 during a connection process of magnetic charging plug 20 to magnetic charging port 30. Energizing electromagnetic alignment magnets 44/46 causes electromagnetic alignment magnets to generate magnetic fields of opposite polarities (e.g., north and south) which cause rotation of magnetic charging plug 20 about longitudinal axis 48 of plug 20 as plug 20 rotates to align electromagnet alignment magnets 44/46 with corresponding alignment magnets 34/36 of the opposite polarity of magnetic charging port 30 of EV 14. Alignment of electromagnetic alignment magnets 44/46 of magnetic charging plug 20 with corresponding alignment magnets 34/36 of magnetic charging port 30 also results in alignment of charging contacts 68 of plug 20 with corresponding charging contacts 38 of charging port 30. Upon alignment, EV station 10, via control system 16, energizes electromagnetic coupling magnet 50 to generate an electric field to magnetically couple electromagnetic coupling magnet 50, and thus plug 20, to coupling magnet 37 of charging port 30. In one example, charging contacts 68 of plug 20 and corresponding charging contacts 38 of charging port 30 are biased against one another by one or more biasing mechanisms, wherein such biasing may be a component of charging plug 20 and/or charging port 30. In one example, to release magnetic charging plug 20 from magnetic charging port 30, electromagnetic coupling magnet 50 is either de-energized or has its magnetic field reversed by control system 16 of EV 10 so that magnetic charging plug 20 can be pulled from and/or ejected from magnetic charging port 30.

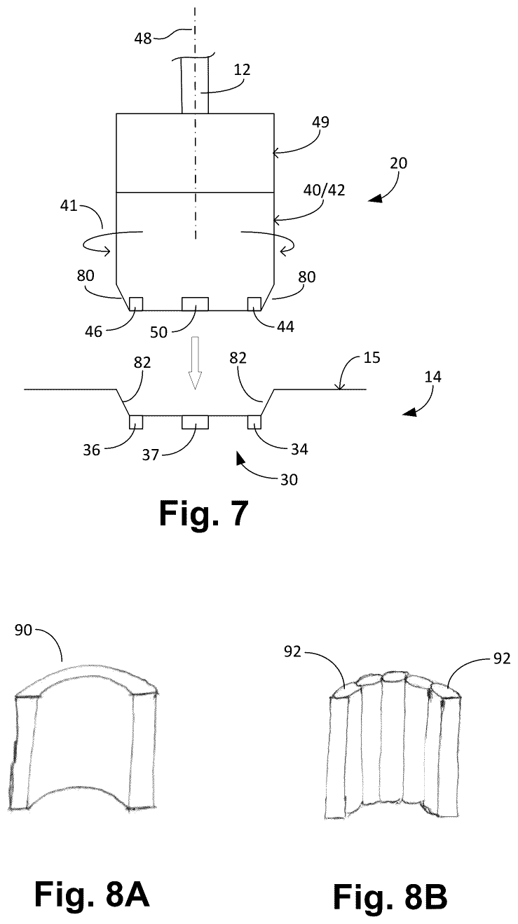

FIG. 7 is a block and schematic diagram generally illustrating magnetic charging plug 20 and EV charging port 30, according to one example. According to the illustrated example, edges 80 of charging plug 20 are sloped to match sloped edges 82 of charging port 30, where sloped edges 80 of charging plug 20 engage and are guided into a recessed opening 84 of charging port 30 by sloped edges 82. As further indicated, outer and inner bodies 40/42 of magnetic charging plug 20 are able to rotate relative to plug body 49 about longitudinal axis 48 of plug 20 to thereby alignment of magnetic alignment magnets 44 and 46 of plug 20 with corresponding alignment magnets 34 and 36 of magnetic charge port 30 of EV 14.

FIGS. 8A and 8B are perspective views of alignment and coupling magnets that may be employed with magnetic charging plug 20 and/or magnetic charging port 30, such as alignment magnets 44/46/34/36 and coupling magnets 50/37. In one example, as illustrated by FIG. 8A, such magnets comprise a single magnet 90 having a north and south pole. In one example, as illustrated by FIG. 8B, such magnets comprise multiple magnets 92 positioned to form a single magnet and arranged to form any desirable shape.

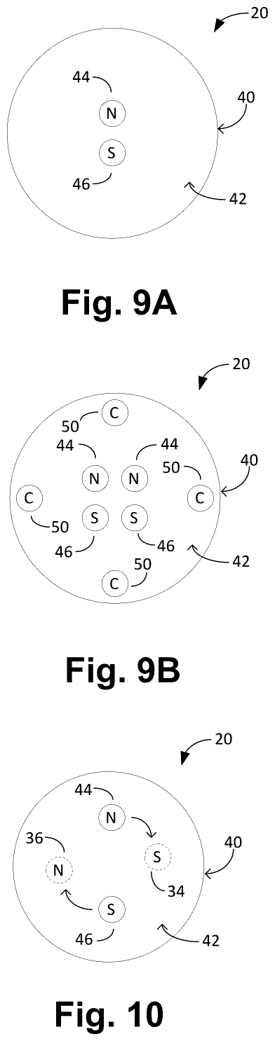

FIGS. 9A and 9B are schematic diagrams representing end views of magnetic charging plugs 20 according to examples of the present disclosure. It is noted that, for illustrative purposes, charging contacts 60 are not shown in FIGS. 9A and 9B. In FIG. 9A, the alignment magnets are illustrated as a single pair of alignment magnets 44 and 46 which are centrally disposed on the end surface of inner region 42. It is noted that magnetic charging plug 20 of FIG. 9A does not include separate coupling magnets, so that alignment magnets 44 and 46 also serve as coupling magnets to magnetically secure magnetic charging plug 20 to magnetic charging port 30 of EV 14. In examples, alignment magnets 44 and 46 may comprise one of permanent magnets and electromagnets.

In FIG. 9, in lieu of a single pair of alignment magnets, magnetic charging plug 20 includes multiple pairs of alignment magnets 44 and 46. In one example, as illustrated, the multiple pairs of alignment magnets are centrally disposed on the end surface of inner body 42. Additionally, a plurality of spaced apart coupling magnets are disposed about a perimeter of inner body 42. In examples, alignment magnets 44 and 46 and coupling magnets 50 may comprise one of permanent magnets and electromagnets.

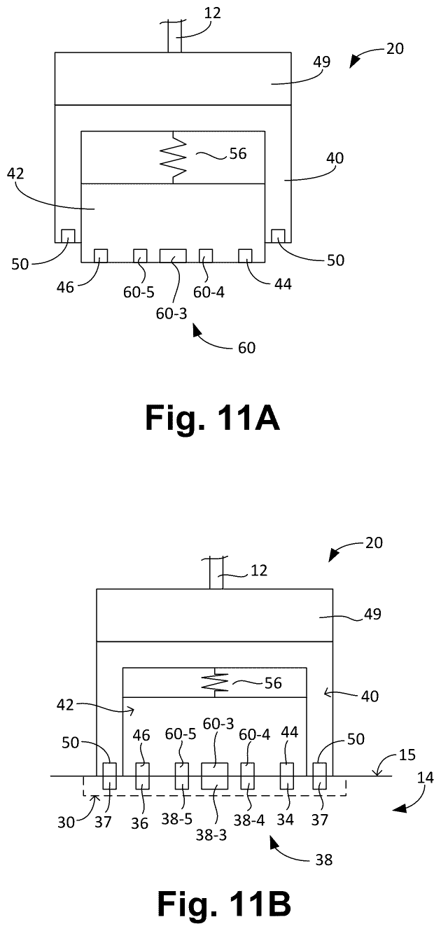

In the examples of FIGS. 9A and 9B, it is further noted that outer body 40 and inner body 42, in some cases, may be fixed relative to one another (i.e., are not moveable relative to one another, where outer body 40 and inner body 42, together, form the end surface of magnetic charging plug 20. In other examples, outer body 40 and inner body 42 may be moveable relative to one another, such as illustrated by FIGS. 3A-3C and 11A-11B.

FIG. 10 is a schematic diagram generally illustrating the alignment of alignment contacts 44 and 46 of magnetic charging plug 20 with corresponding alignment contacts 34 and 36 of magnetic charging port 30 of EV 14, where only the alignment contacts 34 and 36 of charging port 30 are shown (in dashed lines). As the end surface of magnetic charging plug 20 is moved into close proximity to alignment magnets 34 and 36, a magnetic force (indicated by the arrows) of attraction between alignment magnets 44 and 46 of charging plug 20 with alignment magnets 34 and 35 of magnetic charging port 30, respectively, causes plug 20 to rotate about its longitudinal axis until magnets 44 and 34, and magnets 46 and 36 align with one another (see also FIG. 7).

FIGS. 10A and 10B are schematic diagrams generally illustrating a cross-sectional view of a magnetic charging plug 20, according to one example of the present disclosure. According to the illustrated example, alignment magnets 44 and 46 are disposed on the end face of inner body 42, and coupling magnet 50 is disposed on the end face of outer body 40, where inner and outer bodies 40 and 42 are vertically moveable relative to one another, and wherein inner and outer bodies 40 and 42 are together rotatable relative to plug body 49 about the central axis of magnetic charging plug 20 (e.g., see FIG. 7). Additionally, inner body 42 is coupled to outer body 42 via a biasing mechanism 56 which biases inner body 42 away from plug body 49.

With reference to FIG. 11B, after alignment magnets 44 and 46 are respectively aligned with and magnetically secured to corresponding alignment magnets 34 and 36 of magnetic charging port 30 of EV 14, electromagnetic coupling magnet 50 is energized (such as by control system 16 of EV charging station 10) with the resulting generated magnetic field pulling coupling magnet 50 into contact with and magnetically securing to coupling magnet 37 of magnetic charging port 30. When electromagnetic coupling magnet 50 is drawn into contact with coupling magnet 37, outer body 40 is also pulled toward magnetic charging port 30 which causes bias mechanism 56 to compress and bias inner body 42 and charging contacts 60 disposed thereon against charging contacts 38 of magnetic charging port 30.

One or more examples and features of the charging system are summarized below.

An Electric Vehicle Charging System with a Magnetic Charging Plug can include a combination of one or more of the following features:

### Electromagnetic Plug and Magnetic Charging Port

Electromagnetic plug connection to charging port and/or to charging station dock.
Can use magnetics to self-align the plug connection to electric vehicle.
Electromagnetic plug with switch. Electromagnetic plug can include switch (e.g., rocker switch) to shut off magnetics. For example, can switch off when done charging or when removing charging plug from charging station dock.
Electromagnetic Alignment/Coupling. Electromagnetic alignment and/or coupling can be “switched off” or “released” by reversing the current flow to one or more electromagnets on the plug.
Magnetic Port Surface. Could be a smooth surface or have a tapered indent configuration to act as a plug connection guide.
Magnetic Port Locations. Could locate in a number of spots on an electric vehicle. Could be located on back side of side mirrors. Could be located near the headlights.
Magnetic Alignment System. The magnetic plug can include a magnetic alignment system for aligning the magnetic plug with an electric vehicle charging port.
Magnetic Coupling System. The magnetic plug can include a magnetic coupling system for coupling the magnetic plug to an ev charging port during a charging operation.
Dual Magnetic Plug System. The Magnetic Plug System can include both a plug magnetic alignment system and a plug magnetic coupling system. In one example, the plug magnetic alignment system comprises a set of magnets located about an (outer) edge configured to aid in aligning the magnetic plug on an ev charging port. The magnetic coupling system comprises a set of magnets located on the charging plug to securely couple the charging plug to an ev charging port during charging of the ev. The magnetic coupling system can also be located about an outer edge of the charging plug.
Electromagnetic Systems. The magnetic alignment system and the magnetic plug system can be electromagnetic systems.

### Plug Operation.

Two Step Process. In one example, the magnetic plug system is a two step system. First, an electromagnetic alignment system is activated for alignment of the magnetic plug system with the ev port. Once aligned, the electromagnetic coupling system is activated for coupling the magnetic plug system to the ev charging port to perform a charging operation. Once magnetically coupled together, the magnetic alignment system can continue to be activated or can be deactivated. Once the vehicle completes a charging operation (is charged to a desired level), the magnetic coupling system (and magnetic alignment system) can be selectively deactivated and/or the direction of the electromagnetic current can be reversed to release the magnetic coupling.
Two Mode Operation. In one example, the electromagnetic plug has a dual mode operation. The first mode is an alignment mode where the electromagnetic plug aligns (e.g., automatically aligns) with an ev charging port using at least one pair of electromagnets. Once aligned, the charging plug second mode is activated where the plug is electromagnetically coupled to the charging port during a charging operation.
In one example, the first alignment mode is a higher powered mode than the second coupling mode, allowing the charging plug to be snap fit aligned to the charging port. In the alignment mode, fewer electromagnets are activated than in the coupling mode but at a higher power to aid in alignment on the charging port.
Magnetic Plug System Control. The magnetic plug system can be controlled via the charging station, including the charging station or charging system control system.
Plug Alignment System. The plug alignment system can include both magnetic alignment components and physical alignment components to aid and assure proper alignment of the charging plug with an ev charging port.
Alignment Electromagnets can be Dual Purpose. The alignment electromagnets can also be used in the coupling mode. In one example, when the alignment electromagnets are used in the coupling mode they are operated at a different power level than during the alignment mode (e.g., a reduced power level).
Heater. Plug can include heated plug design. EV Charging port can be heated. Can be temperature activated for use in harsh winter conditions to avoid freezing rain and snow issues.
Shutoff System. Electromagnetic Plugs can be shut off via software, or can include a physical switch to shut off magnetics. For example, a rocker switch could shut off magnetics when removing a plug from a charging port.

### Plug Design Options

In one example, the charging plug includes electro magnets and the ev charging port includes permanent magnets or ferris material.
The ev charging plug can be circular shaped, or it can take on a number of other shapes such as being oval shaped or square shaped.
Plug shape. In one example, the charging port has a flat, smooth surface. In other examples, the charging port includes a semi-conical shaped or other shaped outer edge to act as a guide for aligning the charging plug with the charging port.
Plug movement. The charging plug is moveable in multiple directions. In one example, the charging plug is moveable in an alignment (e.g., rotatable) direction and in a coupling direction (e.g., perpendicular to the charging port surface).
Electromagnet locations. Electromagnets used for alignment and/or coupling can be located near an outer edge of a charging plug, near the center of the charging plug, or both. The location of the electromagnets used for alignment and coupling correspond to the location of magnets (electromagnets or more probably a ferromagnetic material) on the charging port.
Plug magnets. The plug magnetics can take on a number of shapes and configurations. In one or more examples, the plug magnets are circular shaped, semi-circular shaped, oval shaped, or linear shaped. In another example, each “plug magnet” is made up of multiple smaller magnets. The end of multiple magnets are positioned together to form a plug magnet much stronger than a single magnet. EV charging port magnets can be configured in a similar manner.
   EV Charging System with Magnetic Plug Adapter and/or Port Adapter
Magnetic Plug Adapter. A magnetic plug adapter can be used to convert an existing physical charging station plug to a magnetic plug for electro magnetic coupling to an ev.
Magnetic Plug Adapter Configuration. In one example, the magnetic plug adapter has a first side configured to physically plug into the charging plug, and has a second side configured to electromagnetically couple to an ev charging port.
EV Magnetic Port Adapter. An ev magnetic port adapter can be used to convert an existing physical ev charging port to a magnetic charging port for electromagnetic coupling to a charging station.
EV Magnetic Port Adapter Configuration. In one example, the ev magnetic port adapter includes a first side that physically couples to the charging port pins, and a second side for magnetically coupling to a magnetic charging plug of a charging station. In one example, the Port Adapter includes a contact layer, a plug connection layer, and a distribution layer. The contact layer can include permanent magnets. For example, the contact layer can include alignment magnets and coupling magnets that align with a charging plug. The plug connection layer is configured to match/couple the adapter to the ev port pins. The distribution layer provides electrical communication between corresponding elements in the contact layer and the plug connection layer.

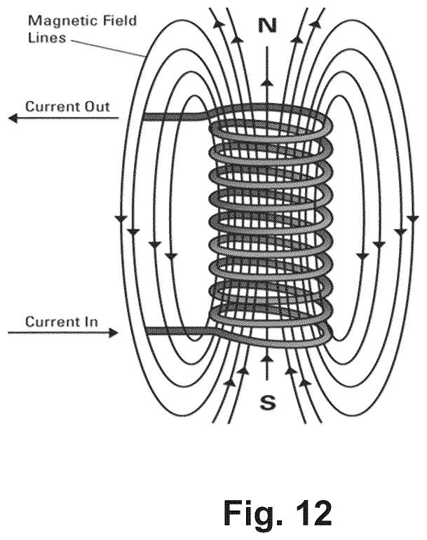

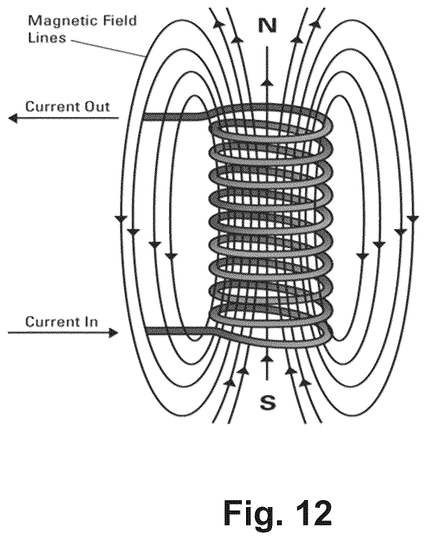

Electromagnet. FIG. 12 schematically illustrates an electromagnet, according to one example. An Electromagnet is different from a permanent magnet. As illustrated by FIG. 12. electromagnets are made of coils of wire with electricity passing through them. Moving charges create magnetic fields, so when the coils of wire in an electromagnet have an electric current passing through them, the coils behave like a magnet. When the electricity stops flowing, the coils no longer behave as a magnet. The polarity of the magnetic field produced by the electromagnet may be reversed by reversing the direction of current flow passing through the coils. A ferrous member may be positioned in the coils.

It is recognized that the charging system including a magnetic plug of the present disclosure can be configured for use in many charging system applications, including those not disclosed herein.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

The claims are part of the specification.

1. An electric vehicle (EV) charging system comprising:
a charging station including a charging plug having an end surface on which at least one pair of alignment magnets and a plurality of charging contacts are arranged in a layout pattern; and
a charging port disposed on an EV having at least one pair of alignment magnets and a plurality of charging contacts which are arranged in the layout pattern on a surface of the charging port, the charging port to receive the charging plug, wherein the alignment magnets of the charging plug magnetically align with and magnetically couple to the alignment magnets of the charging port such that the charging contacts of the charging plug are aligned with an in electrical contact with the charging contacts of the charging port.

2. The EV charging system of claim 1, wherein the charging plug further includes at least one coupling magnet which aligns with a corresponding coupling magnet of the charging port when the alignment magnets of the charging plug are magnetically coupled to the alignment magnets of the charging port, wherein the coupling magnets are magnetically coupled to one another to secure the charging plug to the charging port.

3. The EV charging system of claim 2, wherein the at least one pair of alignment magnets and the at least one coupling magnet of the charging plug comprise electromagnets.

4. The EV charging system of claim 2, wherein the at least one pair of alignment magnets and the at least one coupling magnet of the charging port comprise permanent magnets.

5. A magnetic charging plug for an EV charging system comprising:
a planar end surface having disposed thereon at least one pair of alignment magnets and a plurality of charging contacts, wherein the at least one pair of alignment magnets and the plurality of charging contacts are arranged in a layout pattern, wherein the at least one pair of alignment magnets are to magnetically align with and magnetically couple to a corresponding pair of alignment magnets of a charging port of an electric vehicle such that the plurality of charging contacts align of the charging plug align with and electrically connect to a corresponding plurality of charging contacts of the charging port.

6. The magnetic charging plug of claim 5, wherein the at least one pair of alignment magnets comprise one of permanent magnets and electromagnets.

7. The magnetic charging plug of claim 5, wherein the magnetic plug includes an outer body and an inner body which are moveable relative one another, wherein end surface of the outer body and inner body together form the end surface of the magnetic charging plug, wherein the at least one pair of alignment magnets are disposed on the end surface of the outer body and the plurality of charging contacts are disposed on the end surface of the inner body.

8. The magnetic charging plug of claim 7, wherein a biasing mechanism biases the inner body such that the end surface of the inner body is biased away from the end surface of the outer body along a longitudinal axis of the magnetic charging plug which extends perpendicular to the end surface of the charging plug.

9. The magnetic plug of claim 8, further including at least one coupling magnet disposed on the end surface of the inner body which aligns with and magnetically couples to a corresponding coupling magnet of the charging port when the alignment magnets of the charging plug are aligned with and magnetically coupled to the alignment magnets of the charging port, wherein the coupling magnet is to draw the inner body toward the charging port such that the plurality of charging contacts of the charging plug are biased against the charging contacts of the charging port.

10. The magnetic charging plug of claim 9, wherein the coupling magnet comprises one of a permanent magnet and an electromagnet.
